(19) United States
(12) Patent Application Publication
(10) Pub. No.: US 2025/0142640 A1
(43) Pub. Date: May 1, 2025

(54) SYSTEM AND METHOD FOR NON-PRIMARY CHANNEL ACCESS (NPCA)

(71) Applicant: NXP USA, Inc., AUSTIN, TX (US)

(72) Inventors: Liwen Chu, San Ramon, CA (US); Kiseon Ryu, San Diego, CA (US); Huizhao Wang, San Jose, CA (US); Hongyuan Zhang, Fremont, CA (US)

(21) Appl. No.: 18/930,805

(22) Filed: Oct. 29, 2024

Related U.S. Application Data
(60) Provisional application No. 63/656,278, filed on Jun. 5, 2024.
(60) Provisional application No. 63/654,528, filed on May 31, 2024.
(60) Provisional application No. 63/550,204, filed on Feb. 6, 2024.
(60) Provisional application No. 63/595,171, filed on Nov. 1, 2023.

(51) Int. Cl. H04W 74/08; H04L 5/00

(52) U.S. Cl. CPC H04W 74/0866; H04L 5/0048

(57) ABSTRACT

Embodiments of a method and apparatus for wireless communications are disclosed. In an embodiment, a wireless device includes a controller configured to determine backoff channels for a Basic Service Set (BSS) operating channel that include a primary channel and a non-primary channel access (NPCA) primary channel and a wireless transceiver configured to announce to a second wireless device the backoff channels of the BSS operating channel and to switch to the NPCA primary channel for communicating between the wireless device and the second wireless device.

### CROSS-REFERENCE TO RELATED APPLICATIONS

This application is entitled to the benefit of U.S. Provisional Patent Application Ser. No. 63/595,171, filed on Nov. 1, 2023, U.S. Provisional Patent Application Ser. No. 63/550,204, filed on Feb. 6, 2024, U.S. Provisional Patent Application Ser. No. 63/654,528, filed on May 31, 2024, and U.S. Provisional Patent Application Ser. No. 63/656,278, filed on Jun. 5, 2024, the contents of which are incorporated by reference herein.

### BACKGROUND

Wireless communications devices, e.g., access points (APs) or non-AP devices can transmit various types of information using different transmission techniques. For example, various applications, such as, Internet of Things (IoT) applications can conduct wireless local area network (WLAN) communications, for example, based on Institute of Electrical and Electronics Engineers (IEEE) 802.11 family of standards (e.g., Wi-Fi standards). In multi-link communications, an access point (AP) multi-link device (MLD) may wirelessly transmit data to one or more wireless stations in a non-AP MLD through one or more wireless communications links. Some applications, for example, video teleconferencing, streaming entertainment, high definition (HD) video surveillance applications, outdoor video sharing applications, etc., require relatively high system throughput. Wireless communications channel switch can be conducted to facilitate the proper data transmission within a wireless communications system, for example, if a primary channel is busy because of an Overlapping Basic Service Set (OBSS) transmit opportunity (TXOP) and/or in-device non-WLAN (e.g., non-WiFi) radio activity.

### SUMMARY

Embodiments of a method and apparatus for communications are disclosed. In an embodiment, a wireless device includes a controller configured to determine backoff channels for a Basic Service Set (BSS) operating channel that include a primary channel and a non-primary channel access (NPCA) primary channel and a wireless transceiver configured to announce to a second wireless device the backoff channels of the BSS operating channel and to switch to the NPCA primary channel for communicating between the wireless device and the second wireless device. Other embodiments are also disclosed.

In an embodiment, the wireless transceiver is further configured to switch to the NPCA primary channel for communicating between the wireless device and the second wireless device when an Overlapping Basic Service Set (OBSS) activity satisfies a channel switch condition.

In an embodiment, the wireless transceiver is further configured to switch to the NPCA primary channel for communicating between the wireless device and the second wireless device at a start of an Overlapping Basic Service Set (OBSS) transmit opportunity (TXOP) or an OBSS physical layer protocol data unit (PPDU), and the channel switch condition announced to the second wireless device comprises an OBSS activity duration threshold.

In an embodiment, when an OBSS PPDU length or OBSS TXOP remaining time is longer than the OBSS activity duration threshold, the wireless device and the second wireless device switch to the NPCA primary channel until the end of the OBSS activity is detected.

In an embodiment, the wireless transceiver is further configured to announce to the second wireless device a switch delay from the primary channel to the NPCA primary channel and a switch delay from the NPCA primary channel to the primary channel.

In an embodiment, the wireless transceiver is further configured to receive from the second wireless device the second wireless device's switch delay from the primary channel to the NPCA primary channel and a switch delay from the NPCA primary channel to the primary channel.

In an embodiment, the wireless transceiver is further configured to execute frame exchanges in the NPCA primary channel after a backoff counter in the NPCA primary channel becomes zero.

In an embodiment, the wireless transceiver is further configured to transmit a trigger frame to solicit a Trigger-based (TB) PPDU from the second wireless device.

In an embodiment, the wireless transceiver is further configured to treat the NPCA primary channel as the primary channel to perform a resource unit (RU) index coding to be carried in a RU allocation field and a PS160 field.

In an embodiment, the wireless transceiver is further configured to indicate in the trigger frame that the RU index coding is based on the NPCA primary channel as the primary channel such that the trigger frame is transmitted after the backoff counter in the NPCA primary channel becomes zero.

In an embodiment, the wireless transceiver is further configured such that a dynamic bandwidth negotiation treats the NPCA primary channel as the primary channel.

In an embodiment, the BSS operating channel is a 160 Megahertz (MHz) BSS operating channel or a 320 MHz BSS operating channel, and wherein the primary channel and the NPCA primary channel are located in a primary 80 MHz channel of the 160 MHz BSS operating channel and a secondary 80 MHz channel of the 160 MHz BSS operating channel, respectively, or located in a primary 160 MHz channel of the 320 MHz BSS operating channel and a secondary 160 MHz channel of the 320 MHz BSS operating channel, respectively.

In an embodiment, the BSS operating channel is an 80 MHz BSS operating channel, and the primary channel and the NPCA primary channel are located in a primary 40 MHz channel of the 80 MHz BSS operating channel and a secondary 40 MHz channel of the 80 MHz BSS operating channel, respectively.

In an embodiment, the wireless device includes a wireless access point (AP), and the second wireless device includes a non-AP station (STA) device.

In an embodiment, the wireless device is compatible with an Institute of Electrical and Electronics Engineers (IEEE) 802.11 protocol.

In an embodiment, the wireless device is a component of a multi-link device (MLD).

In an embodiment, a wireless access point (AP) includes a controller configured to determine a primary channel and at least one non-primary channel access (NPCA) primary channel for a Basic Service Set (BSS) operating channel and a wireless transceiver configured to announce to a second wireless device the primary channel and the at least one NPCA primary channel of the BSS operating channel and to execute a non-primary channel access (NPCA) channel switch operation to switch to the at least one NPCA primary channel from the primary channel for communicating between the wireless AP and the second wireless device.

In an embodiment, the at least one NPCA primary channel includes at least one 20 Megahertz (MHz) channel.

In an embodiment, the wireless AP is compatible with an Institute of Electrical and Electronics Engineers (IEEE) 802.11 protocol.

In an embodiment, a method for wireless communications involves at a wireless device, determining backoff channels for a Basic Service Set (BSS) operating channel and at the wireless device, announcing to a second wireless device the backoff channels of the BSS operating channel and switching to one of the backoff channels for communicating between the wireless device and the second wireless device.

Other aspects in accordance with the invention will become apparent from the following detailed description, taken in conjunction with the accompanying drawings, illustrated by way of example of the principles of the invention.

### BRIEF DESCRIPTION OF THE DRAWINGS

FIG. 1 depicts a wireless communications system in accordance with an embodiment of the invention.

FIG. 2 depicts a multi-link (ML) communications system that is used for wireless communications in accordance with an embodiment of the invention.

FIG. 3 depicts a wireless device in accordance with an embodiment of the invention.

FIG. 4 depicts an example channel switch operation in accordance with an embodiment of the invention.

FIG. 5 depicts an example resource unit (RU) index configuration for a 160 MHz BSS operating channel.

FIG. 6 depicts an example RU index configuration for a 320 MHz BSS operating channel.

FIG. 7 depicts an RU index configuration for a 320 MHz BSS operating channel in accordance with an embodiment of the invention.

FIG. 8 depicts an RU index configuration for a 320 MHz BSS operating channel in accordance with an embodiment of the invention.

FIG. 9 depicts an RU index configuration for a 160 MHz BSS operating channel in accordance with an embodiment of the invention.

FIG. 10 depicts an RU index configuration for a 320 MHz BSS operating channel in accordance with an embodiment of the invention.

FIG. 11 depicts an RU index configuration for a 320 MHz BSS operating channel in accordance with an embodiment of the invention.

FIG. 12 depicts an RU index configuration for a 160 MHz BSS operating channel in accordance with an embodiment of the invention.

FIG. 13 depicts an RU index configuration for a 320 MHz BSS operating channel in accordance with an embodiment of the invention.

FIG. 14 depicts an RU index configuration for a 320 MHz BSS operating channel in accordance with an embodiment of the invention.

FIG. 15 depicts an RU index configuration for a 160 MHz BSS operating channel BS in accordance with an embodiment of the invention.

FIG. 16 is a process flow diagram of a method for wireless communications in accordance with an embodiment of the invention.

Throughout the description, similar reference numbers may be used to identify similar elements.

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment”, “an embodiment”, or similar language means that a particular feature, structure, or characteristic described in connection with the indicated embodiment is included in at least one embodiment of the present invention. Thus, the phrases “in one embodiment”, “in an embodiment”, and similar language throughout this specification may, but do not necessarily, all refer to the same embodiment.

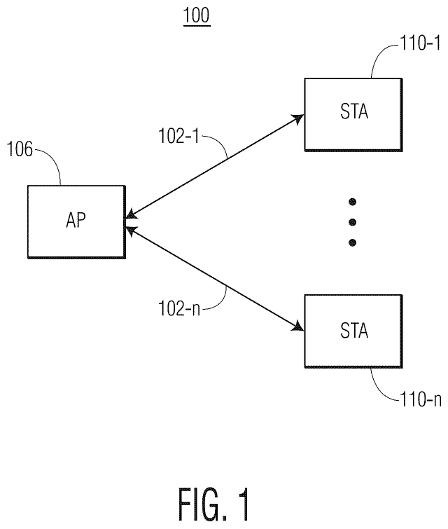

FIG. 1 depicts a wireless (e.g., WiFi) communications system 100 in accordance with an embodiment of the invention. In the embodiment depicted in FIG. 1, the wireless communications system 100 includes at least one AP 106 and at least one station (STA) 110-1, . . . , 110-n, where n is a positive integer. The wireless communications system can be used in various applications, such as industrial applications, medical applications, computer applications, and/or consumer or enterprise applications. In some embodiments, the wireless communications system is compatible with an IEEE 802.11 protocol. Although the depicted wireless communications system 100 is shown in FIG. 1 with certain components and described with certain functionality herein, other embodiments of the wireless communications system may include fewer or more components to implement the same, less, or more functionality. For example, in some embodiments, the wireless communications system includes multiple APs with multiple STAs, one AP with one STA, or one AP with multiple STAs. In another example, although the wireless communications system is shown in FIG. 1 as being connected in a certain topology, the network topology of the wireless communications system is not limited to the topology shown in FIG. 1. In some embodiments, the wireless communications system 100 described with reference to FIG. 1 involves single-link communications and the AP and the STA communicate through single communications link. In some embodiments, the AP 106 may be affiliated with an AP MLD, and a STA 100-j with j being an integer equal to one of 1 to n with n being an integer may be affiliated with a STA MLD j (=non-AP MLD j).

In the embodiment depicted in FIG. 1, the AP 106 may be implemented in hardware (e.g., circuits), software, firmware, or a combination thereof. The AP 106 may be fully or partially implemented as an integrated circuit (IC) device. In some embodiments, the AP 106 is a wireless AP compatible with at least one WLAN communications protocol (e.g., at least one IEEE 802.11 protocol). In some embodiments, the AP is a wireless AP that connects to a local area network (LAN) and/or to a backbone network (e.g., the Internet) through a wired connection and that wirelessly connects to one or more wireless stations (STAs), for example, through one or more WLAN communications protocols, such as the IEEE 802.11 protocol. In some embodiments, the AP includes at least one antenna, at least one transceiver operably connected to the at least one antenna, and at least one controller operably connected to the corresponding transceiver. In some embodiments, the transceiver includes a physical layer (PHY) device. The controller may be configured to control the transceiver to process received packets through the antenna. In some embodiments, the controller is implemented within a processor, such as a microcontroller, a host processor, a host, a digital signal processor (DSP), or a central processing unit (CPU), which can be integrated in a corresponding transceiver. In some embodiments, the AP 106 (e.g., a controller or a transceiver of the AP) implements upper layer Media Access Control (MAC) functionalities (e.g., beaconing, block acknowledgement agreement establishment, reordering of frames, etc.) and/or lower layer MAC functionalities (e.g., backoff, frame transmission, frame reception, etc.). Although the wireless communications system 100 is shown in FIG. 1 as including one AP, other embodiments of the wireless communications system 100 may include multiple APs. In these embodiments, each of the APs of the wireless communications system 100 may operate in a different frequency band. For example, one AP may operate in a 2.4 gigahertz (GHz) frequency band and another AP may operate in a 5 GHz frequency band.

In the embodiment depicted in FIG. 1, each of the at least one STA 110-1, . . . , 110-n may be implemented in hardware (e.g., circuits), software, firmware, or a combination thereof. The STA 110-1, . . . , or 110-n may be fully or partially implemented as IC devices. In some embodiments, the STA 110-1, . . . , or 110-n is a communication device compatible with at least one IEEE 802.11protocol. In some embodiments, the STA 110-1, . . . , or 110-n is implemented in a laptop, a desktop personal computer (PC), a mobile phone, or other communications device that supports at least one WLAN communications protocol. In some embodiments, the STA 110-1, . . . , or 110-n implements a common MAC data service interface and a lower layer MAC data service interface. In some embodiments, the STA 110-1, . . . , or 110-n includes at least one antenna, at least one transceiver operably connected to the at least one antenna, and at least one controller connected to the corresponding transceiver. In some embodiments, the transceiver includes a PHY device. The controller may be configured to control the transceiver to process received packets through the antenna. In some embodiments, the controller is implemented within a processor, such as a microcontroller, a host processor, a host, a DSP, or a CPU, which can be integrated in a corresponding transceiver.

In the embodiment depicted in FIG. 1, the AP 106 communicates with the at least one STA 110-1, . . . , 110-n via a communication link 102-1, . . . , 102-n, where n is a positive integer. In some embodiments, data communicated between the AP and the at least one STA 110-1, . . . , 110-n includes MAC protocol data units (MPDUs). An MPDU may include a frame header, a frame body, and a trailer with the MPDU payload encapsulated in the frame body.

In some embodiments of a wireless communications system, a wireless device, e.g., an access point (AP) multi-link device (MLD) of a wireless local area network (WLAN) may transmit data to at least one associated station (STA) MLD (as also referred to as a non-AP MLD). The AP MLD may be configured to operate with associated STA MLDs according to a communication protocol. For example, the communication protocol may be an Ultra High Reliability (UHR) communication protocol, or Institute of Electrical and Electronics Engineers (IEEE) 802.11bn communication protocol. In some embodiments of the wireless communications system described herein, different associated STAs within range of an AP operating according to the UHR communication protocol are configured to operate according to at least one other communication protocol, which defines operation in a Basic Service Set (BSS) with the AP, but are generally affiliated with lower reliable protocols. The lower reliable communication protocols (e.g., Extremely High Throughput (EHT) communication protocol that is compatible with IEEE 802.11be standards, High Efficiency (HE) communication protocol that is compatible with IEEE 802.11ax standards, Very High Throughput (VHT) communication protocol that is compatible with IEEE 802.11ac standards, etc.) may be collectively referred to herein as “legacy” communication protocols.

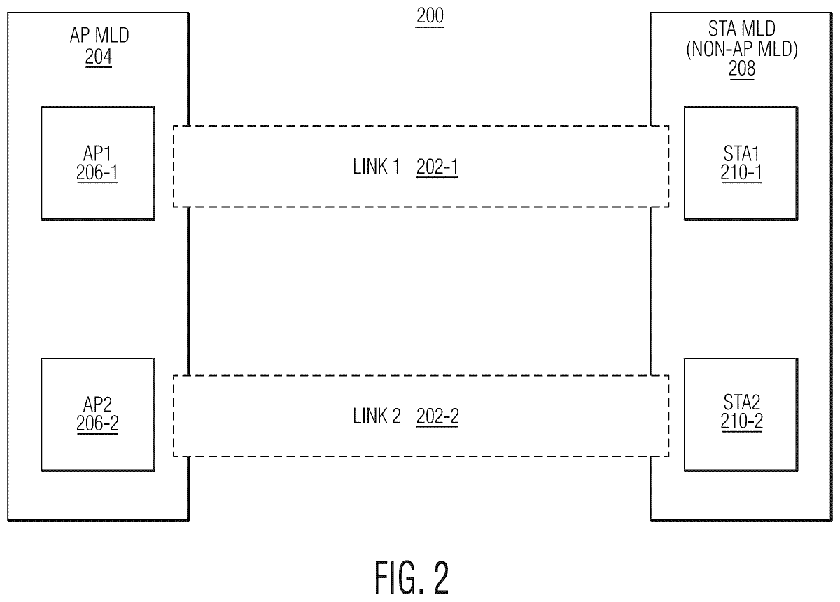

FIG. 2 depicts a multi-link (ML) communications system 200 that is used for wireless (e.g., WiFi) communications in accordance with an embodiment of the invention. In the embodiment depicted in FIG. 2, the multi-link communications system includes one AP multi-link device, which is implemented as AP MLD 204, and one non-AP STA multi-link device, which is implemented as STA MLD (non-AP MLD) 208. The multi-link communications system can be used in various applications, such as industrial applications, medical applications, computer applications, and/or consumer or enterprise applications. In some embodiments, the multi-link communications system may be a wireless communications system, such as a wireless communications system compatible with an IEEE 802.11 protocol. For example, the multi-link communications system may be a wireless communications system compatible with an IEEE 802.11bn protocol. Although the depicted multi-link communications system 200 is shown in FIG. 2 with certain components and described with certain functionality herein, other embodiments of the multi-link communications system may include fewer or more components to implement the same, less, or more functionality. For example, in some embodiments, the multi-link communications system includes a single AP MLD with multiple STA MLDs, or multiple AP MLDs with more than one STA MLD. In some embodiments, the legacy STAs (non-UHR STAs) may associate with one of the APs affiliated with the AP MLD. In another example, although the multi-link communications system is shown in FIG. 2 as being connected in a certain topology, the network topology of the multi-link communications system is not limited to the topology shown in FIG. 2.

In the embodiment depicted in FIG. 2, the AP MLD 204 includes two APs in two links, implemented as APs 206-1 and 206-2. In such an embodiment, the APs may be AP1 206-1 and AP2 206-2. In some embodiments, a common part of the AP MLD 204 implements upper layer Media Access Control (MAC) functionalities (e.g., beaconing, association establishment, reordering of frames, etc.) and a link specific part of the AP MLD 204, i.e., the APs 206-1 and 206-2, implement lower layer MAC functionalities (e.g., backoff, frame transmission, frame reception, etc.). The APs 206-1 and 206-2 may be implemented in hardware (e.g., circuits), software, firmware, or a combination thereof. The APs 206-1 and 206-2 may be fully or partially implemented as an integrated circuit (IC) device. In some embodiments, the APs 206-1 and 206-2 may be wireless APs compatible with at least one WLAN communications protocol (e.g., at least one IEEE 802.11 protocol). For example, the APs 206-1 and 206-2 may be wireless APs compatible with an IEEE 802.11bn protocol. In some embodiments, an AP MLD (e.g., AP MLD 204) connects to a local network (e.g., a LAN) and/or to a backbone network (e.g., the Internet) through a wired connection and wirelessly connects to wireless STAs, for example, through one or more WLAN communications protocols, such as an IEEE 802.11 protocol. In some embodiments, an AP (e.g., AP1 206-1 and/or AP2 106-2) includes at least one antenna, at least one transceiver operably connected to the at least one antenna, and at least one controller operably connected to the corresponding transceiver. In some embodiments, at least one transceiver includes a physical layer (PHY) device. The at least one controller may be configured to control the at least one transceiver to process received packets through the at least one antenna. In some embodiments, the at least one controller may be implemented within a processor, such as a microcontroller, a host processor, a host, a digital signal processor (DSP), or a central processing unit (CPU), which can be integrated in a corresponding transceiver. In some embodiments, each of the APs 206-1 or 206-2 of the AP MLD 204 may operate in a different BSS operating channel. For example, AP1 206-1 may operate in a 320 MHz (one million hertz) BSS operating channel at 6 Gigahertz (GHz) band and AP2 206-2 may operate in a 160 MHz BSS operating channel at 5 GHz band. Although the AP MLD 204 is shown in FIG. 2 as including two APs, other embodiments of the AP MLD 204 may include more than two APs or only one AP.

In the embodiment depicted in FIG. 2, the non-AP STA multi-link device, implemented as STA MLD 208, includes non-AP STAs 210-1 and 210-2 on two links. In such an embodiment, the non-AP STAs may be STA1 210-1 and STA2 210-2. The STAs 210-1 and 210-2 may be implemented in hardware (e.g., circuits), software, firmware, or a combination thereof. The STAs 210-1 and 210-2 may be fully or partially implemented as an IC device. In some embodiments, the non-AP STAs 210-1 and 210-2 are part of the STA MLD 208, such that the STA MLD may be a communications device that wirelessly connects to a wireless AP MLD. For example, the STA MLD 208 may be implemented in a laptop, a desktop personal computer (PC), a mobile phone, or other communications device that supports at least one WLAN communications protocol. In some embodiments, the non-AP STA MLD 208 is a communications device compatible with at least one IEEE 802.11 protocol (e.g., an IEEE 802.11 bn protocol, an 802.11be protocol, an IEEE 802.11ax protocol, or an IEEE 802.11ac protocol). In some embodiments, the STA MLD 208 implements a common MAC data service interface and the non-AP STAs 210-1 and 210-2 implement a lower layer MAC data service interface.

In some embodiments, the AP MLD 204 and/or the STA MLD 208 may identify which communication links support multi-link operation during a multi-link operation setup phase and/or exchanges information regarding multi-link capabilities during the multi-link operation setup phase. In some embodiments, each of the non-AP STAs 210-1 and 210-2 of the STA MLD 208 may operate in a different frequency band. For example, the non-AP STA 210-1 may operate in the 2.4 GHz frequency band and the non-AP STA 210-2 may operate in the 5 GHz frequency band. In some embodiments, each STA includes at least one antenna, at least one transceiver operably connected to the at least one antenna, and at least one controller connected to the corresponding transceiver. In some embodiments, at least one transceiver includes a PHY device. The at least one controller may be configured to control the at least one transceiver to process received packets through the at least one antenna. In some embodiments, the at least one controller may be implemented within a processor, such as a microcontroller, a host processor, a host, a DSP, or a CPU, which can be integrated in a corresponding transceiver.

In the embodiment depicted in FIG. 2, the STA MLD 208 communicates with the AP MLD 204 via two communication links, e.g., link 1 202-1 and link 2 202-2. For example, each of the non-AP STAs 210-1 or 210-2 communicates with an AP 206-1 or 206-2 via corresponding communication links 202-1 or 202-2. In an embodiment, a communication link (e.g., link 1 202-1 or link 2 202-2) may include a BSS operating channel established by an AP (e.g., AP1 206-1 or AP2 206-2) that features multiple 20 MHz channels used to transmit frames (e.g., beacon frames, management frames, etc. in Physical Layer Protocol Data Units (PPDUs)) between a first wireless device (e.g., an AP, an AP MLD, an STA, or an STA MLD) and a second wireless device (e.g., an AP, an AP MLD, an STA, or an STA MLD). In some embodiments, a 20 MHz channel covered by the BSS operating channel may be a punctured 20 MHz channel or an unpunctured 20 MHz channel. Although the STA MLD 208 is shown in FIG. 2 as including two non-AP STAs, other embodiments of the STA MLD 208 may include one non-AP STA or more than two non-AP STAs. In addition, although the AP MLD 204 communicates (e.g., wirelessly communicates) with the STA MLD 208 via the communications links 202-1 and 202-2, in other embodiments, the AP MLD 204 may communicate (e.g., wirelessly communicate) with the STA MLD 208 via more than two communication links or less than two communication links.

In some embodiments, a first MLD, e.g., an AP MLD or STA MLD (as also referred to as non-AP MLD), may transmit MLD-level management frames in a multi-link operation with a second MLD, e.g., STA MLD or AP MLD, to coordinate the multi-link operation between the first MLD and the second MLD. As an example, a management frame may be a channel switch announcement frame, a (Re) Association Request frame, a (Re) Association Response frame, a Disassociation frame, an Authentication frame, and/or a Block Acknowledgement (Ack) (BA) Action frame, etc. In some embodiments, an AP/STA of a first MLD may transmit link-level management frames to a STA/AP of a second MLD. In some embodiments, one or more link-level management frames may be transmitted via a cross-link transmission (e.g., according to an IEEE 802.11bn communication protocol). As an example, a cross-link management frame transmission may involve a management frame being transmitted and/or received on one link (e.g., link 1 202-1) while carrying information of another link (e.g., link 2 202-2). In some embodiments, a management frame is transmitted on any link (e.g., at least one of two links or at least one of multiple links) between a first MLD (e.g., AP MLD 204) and a second MLD (e.g., STA MLD 208). As an example, a management frame may be transmitted between a first MLD and a second MLD on any link (e.g., at least one of two links or at least one of multiple links) associated with the first MLD and the second MLD.

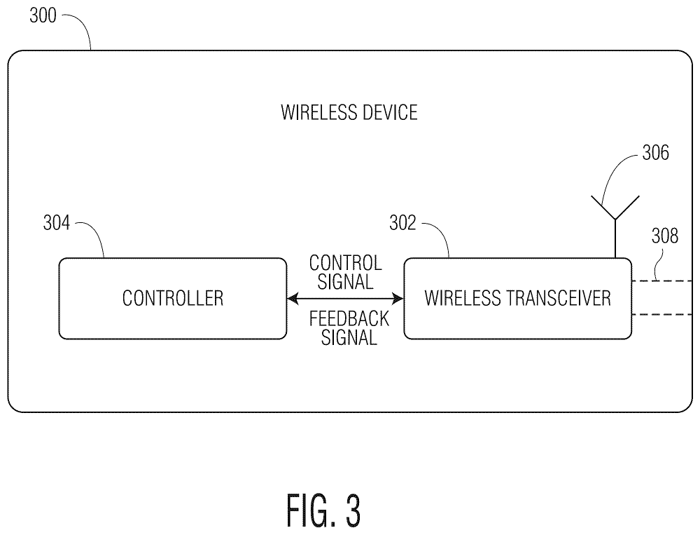

FIG. 3 depicts a wireless device 300 in accordance with an embodiment of the invention. The wireless device 300 can be used in the wireless communications system 100 depicted in FIG. 1 and/or the multi-link communications system 200 depicted in FIG. 2 for each link independently. For example, the wireless device 300 may be an embodiment of the AP 106 depicted in FIG. 1, the STA 110-1, . . . , 110-n depicted in FIG. 1, the APs 206-1, 206-2 depicted in FIG. 2, and/or the STAs 210-1, 210-2 depicted in FIG. 2. In the embodiment depicted in FIG. 3, the wireless device 300 includes a wireless transceiver 302, a controller 304 operably connected to the wireless transceiver, and at least one antenna 306 operably connected to the wireless transceiver. In some embodiments, the wireless device 300 may include at least one optional network port 308 operably connected to the wireless transceiver. The wireless device 300 may be fully or partially implemented as an IC device. In some embodiments, the wireless transceiver 302 and/or the controller 304 may be implemented in a single chip. In some embodiments, the wireless transceiver includes a physical layer (PHY) device. The wireless transceiver may be any suitable type of wireless transceiver. For example, the wireless transceiver may be a LAN transceiver (e.g., a transceiver compatible with an IEEE 802.11 protocol). In some embodiments, the wireless device 300 includes multiple transceivers. The controller may be configured to control the wireless transceiver (e.g., by generating a control signal) to process packets received through the antenna and/or the network port and/or to generate outgoing packets to be transmitted through the antenna and/or the network port. In some embodiments, the wireless transceiver transmits one or more feedback signals to the controller. In some embodiments, the controller is implemented within a processor, such as a microcontroller, a host processor, a host, a DSP, or a CPU. In some embodiments, the wireless transceiver 302 is implemented in hardware (e.g., circuits), software, firmware, or a combination thereof. The antenna may be any suitable type of antenna. For example, the antenna may be an induction type antenna such as a loop antenna or any other suitable type of induction type antenna. However, the antenna is not limited to an induction type antenna. The network port may be any suitable type of port. In some embodiments, an interference source (not shown) is located within the wireless device. For example, the interference source may be an in-device coexisting transmitter/radio (e.g., a Bluetooth transmitter/radio) and/or other known interference source. In some embodiments, the wireless device 300 may further include a second wireless transceiver, and the interference source includes the second wireless transceiver. In some embodiments, the wireless transceiver 302 is compatible with an Institute of Electrical and Electronics Engineers (IEEE) 802.11 protocol, while the second wireless transceiver is not compatible with the IEEE 802.11 protocol. For example, the second wireless transceiver may be compatible with a short range wireless communications protocol (e.g., a Bluetooth communications protocol). Wireless communications interference (e.g., wireless transmissions of in-device coexisting radio(s), such as, a Bluetooth transmitter) can affect wireless communication throughput (e.g., wireless communication throughput of a WLAN (e.g., Wi-Fi) transmitter).

In accordance with an embodiment of the invention, the controller 304 is configured to determine multiple backoff channels for a Basic Service Set (BSS) operating channel and the wireless transceiver 302 is configured to announce to a second wireless device the backoff channels of the BSS operating channel and to switch to one of the backoff channels for communicating between the wireless device and the second wireless device, for example, through the at least one antenna 306. In some embodiments, the wireless transceiver 302 is further configured to switch to the one of the backoff channels for communicating between the wireless device and the second wireless device when an Overlapping Basic Service Set (OBSS) activity satisfies a channel switch condition. In some embodiments, the wireless transceiver 302 is further configured to switch to the one of the backoff channels for communicating between the wireless device 300 and the second wireless device at a start of an OBSS transmit opportunity (TXOP) or an OBSS physical layer protocol data unit (PPDU). In some embodiments, the backoff channels include a primary channel and a non-primary backoff channel of the BSS operating channel. In some embodiments, the wireless transceiver 302 is further configured to wirelessly transmit a first data unit to the second wireless device in the non-primary backoff channel or wirelessly receive a second data unit from the second wireless device in the non-primary backoff channel. In some embodiments, the wireless transceiver 302 is further configured to execute a non-primary channel access (NPCA) primary channel switch operation to switch to the non-primary backoff channel from the primary channel for communicating between the wireless device 300 and the second wireless device when an OBSS activity covering the primary channel satisfies an NPCA primary channel switch condition. In some embodiments, the wireless transceiver 302 is further configured to execute the NPCA primary channel switch operation to switch from the primary channel to the non-primary backoff channel for communicating between the wireless device and the second wireless device at a start of an OBSS TXOP or an OBSS PPDU. In some embodiments, the wireless transceiver 302 is further configured to execute the NPCA primary channel switch operation to switch to the non-primary backoff channel for communicating between the wireless device 300 and the second wireless device when the primary channel is busy. In some embodiments, the one of the backoff channels includes one 20 Megahertz (MHz) channel. In some embodiments, the BSS operating channel includes a 160 MHz BSS operating channel or a 320 MHz BSS operating channel, and the primary channel and a secondary backoff channel are located in a primary 80 MHz channel of the 160 MHz BSS operating channel and a secondary 80 MHz channel of the 160 MHz BSS operating channel, respectively, or located in a primary 160 MHz channel of the 320 MHz BSS operating channel and a secondary 160 MHz channel of the 320 MHz BSS operating channel, respectively. In some embodiments, the controller 304 is configured to allocate different priorities to the backoff channels. In some embodiments, the wireless transceiver 302 is further configured to announce to the second wireless device the backoff channels using a management frame, and the management frame is one of a beacon frame, a probe response frame, and an association response frame. In some embodiments, the wireless device 300 includes a wireless access point (AP), and the second wireless device includes a non-AP station (STA) device. In some embodiments, the wireless device 300 is compatible with an Institute of Electrical and Electronics Engineers (IEEE) 802.11 protocol. In some embodiments, the wireless device 300 is a component of a multi-link device (MLD). In some embodiments, the communications after switching to the non-primary backoff channel include frame exchanges on the non-primary backoff channel combined with other secondary channels where the combination cannot use secondary channels that are occupied by the OBSS activity. In some embodiments, the communications after switching to the non-primary backoff channel include frame exchanges on the non-primary backoff channel combined with other secondary channels where the combination satisfies IEEE 802.11be puncture rules with the non-primary backoff channel being treated as the primary channel.

In accordance with an embodiment of the invention, the controller 304 is configured to determine backoff channels for a Basic Service Set (BSS) operating channel that include a primary channel and a non-primary channel access (NPCA) primary channel and the wireless transceiver 302 is configured to announce to a second wireless device the backoff channels of the BSS operating channel and to switch to the NPCA primary channel for communicating between the wireless device 300 and the second wireless device, for example, through the at least one antenna 306. In some embodiments, the wireless transceiver 302 is further configured to switch to the NPCA primary channel for communicating between the wireless device and the second wireless device when an OBSS activity satisfies a channel switch condition. In some embodiments, the wireless transceiver 302 is further configured to switch to the NPCA primary channel for communicating between the wireless device and the second wireless device at a start of an OBSS transmit opportunity (TXOP) or an OBSS physical layer protocol data unit (PPDU), and the channel switch condition announced to the second wireless device includes an OBSS activity duration threshold. In some embodiments, when an OBSS PPDU length or OBSS TXOP remaining time is longer than the OBSS activity duration threshold, the wireless device and the second wireless device switch to the NPCA primary channel until the end of the OBSS activity is detected. In some embodiments, the wireless transceiver 302 is further configured to announce to the second wireless device a switch delay from the primary channel to the NPCA primary channel and a switch delay from the NPCA primary channel to the primary channel. In some embodiments, the wireless transceiver 302 is further configured to receive from the second wireless device the second wireless device's switch delay from the primary channel to the NPCA primary channel and a switch delay from the NPCA primary channel to the primary channel. In some embodiments, the wireless transceiver 302 is further configured to execute frame exchanges in the NPCA primary channel after a backoff counter in the NPCA primary channel becomes zero. In some embodiments, the wireless transceiver 302 is further configured to transmit a trigger frame to solicit a Trigger-based (TB) PPDU from the second wireless device. In some embodiments, the wireless transceiver 302 is further configured to treat the NPCA primary channel as the primary channel to perform a resource unit (RU) index coding to be carried in a RU allocation field and a PS160 field. In some embodiments, the wireless transceiver 302 is further configured to indicate in the trigger frame that the RU index coding is based on the NPCA primary channel as the primary channel such that the trigger frame is transmitted after the backoff counter in the NPCA primary channel becomes zero. In some embodiments, the wireless transceiver 302 is further configured such that a dynamic bandwidth negotiation treats the NPCA primary channel as the primary channel. In some embodiments, the BSS operating channel is 160 MHz BSS operating channel or 320 MHz BSS operating channel, and the primary channel and the NPCA primary channel are located in a primary 80 MHz channel of the 160 MHz BSS operating channel and a secondary 80 MHz channel of the 160 MHz BSS operating channel, respectively, or located in a primary 160 MHz channel of the 320 MHz BSS operating channel and a secondary 160 MHz channel of the 320 MHz BSS operating channel, respectively. In some embodiments, the BSS operating channel is 80 MHz BSS operating channel, and where the primary channel and the NPCA primary channel are located in a primary 40 MHz channel of the 80 MHz BSS operating channel and a secondary 40 MHz channel of the 80 MHz BSS operating channel, respectively. In some embodiments, the wireless device 300 includes a wireless access point (AP), and the second wireless device includes a non-AP station (STA) device. In some embodiments, the wireless device 300 is compatible with an Institute of Electrical and Electronics Engineers (IEEE) 802.11 protocol. In some embodiments, the wireless device 300 is a component of a multi-link device (MLD).

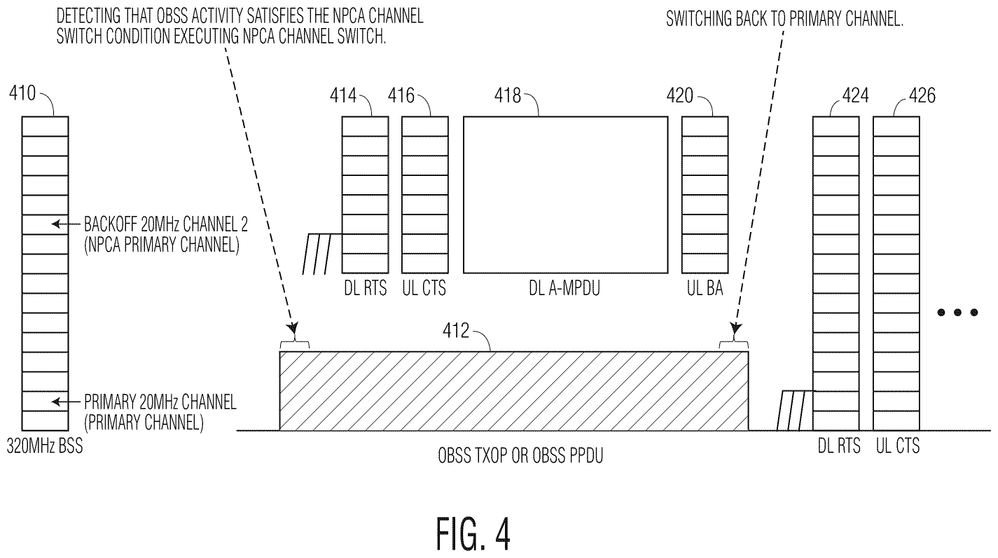

In some embodiments, a BSS operating channel (e.g., a BSS operating channel of 320 MHz) includes a primary channel (e.g., 20 MHz) and one or more non-primary backoff channel (e.g., 20 MHZ) (also referred to a non-primary channel access (NPCA) primary channel). FIG. 4 depicts an example channel switch operation in accordance with an embodiment of the invention. For example, a 320 MHz BSS operating channel 410 includes a primary 20 MHz channel (also referred to as a primary channel) and a backoff 20 MHz channel (also referred to an NPCA primary channel). In the example channel switch operation depicted in FIG. 4, a wireless device (e.g., an AP) may execute an NPCA primary channel switch operation to switch from the primary channel to the secondary backoff channel (e.g., the NPCA primary channel) to conduct frame exchanges in the secondary channel when the wireless device detects that an Overlapping Basic Service Set (OBSS) activity satisfies an NPCA primary channel switch condition at a start of an OBSS transmit opportunity (TXOP) or an OBSS PPDU 412 and switches back to the primary channel from the secondary channel to conduct frame exchanges in the primary channel at the end of the OBSS TXOP or the OBSS PPDU. In some embodiments, the frame exchanges after switching to the NPCA primary channel means the frame exchanges on the NPCA primary channel combined with the other secondary channels where the combination cannot use the secondary channels that are occupied by the OBSS activity. In some embodiments, the communication after switching to the NPCA primary channel means the frame exchanges on the NPCA primary channel combined with the other secondary channels where the combination satisfies the IEEE 802.11be puncture rules with NPCA primary channel being treated as primary channel. In some embodiments, after switching to the NPCA primary channel, a downlink (DL) Request to Send (RTS) 414, an uplink (UL) Clear to Send (CTS) 416, a DL aggregate MAC protocol data unit (A-MPDU) 418, and an UL block acknowledgement (BA) 420 are successively transmitted. After switching to the NPCA primary channel, a DL RTS 424 and an UL CTS 426 or another control frame exchange are transmitted for the TXOP holder to check whether the TXOP responder switched to NPCA primary channel.

Some implementations of non-primary backoff 20 MHz channel location, for example, by the wireless communications system 100 depicted in FIG. 1, the multi-link (ML) communications system 200 depicted in FIG. 2, and/or the wireless device 300 depicted in FIG. 3 are described.

In some embodiments, in a first option, each 80 MHz channel covered by a BSS operating channel cannot have more than one backoff channel (a backoff channel is either a non-primary backoff channel (NPCA primary channel) or the primary channel). In some embodiments, in a BSS with N 20 MHz channels (N being a positive integer greater than one), if an AP indicates an NPCA primary channel (the backoff 20 MHz channel that is not primary channel), the NPCA primary channel is on non-primary (secondary) (N/2)*20 MHz channel. For example, in a 320 MHz BSS, the NPCA primary channel is on secondary 160 MHz channel. In 160 MHz BSS, the NPCA primary channel may be on secondary 80 MHz channel.

In some embodiments, in a second option, each 80 MHz channel covered by a BSS operating channel cannot have more than one backoff 20 MHz channel. In some embodiments, in a BSS with N 20 MHz channels (N being a positive integer greater than one), if the AP indicates M NPCA primary channels (M being a positive integer), the NPCA primary channels are on non-primary (N/(M+1))*20 MHz channels where each non-primary (N/(M+1))*20 MHz channel has a NPCA primary channel. For example, in a 320 MHz BSS, the three NPCA primary 20 MHz channels are on secondary 80 MHz channel, two secondary 80 MHz channels of secondary 160 MHz channel.

In some embodiments, in a third option, the first option and the second option are relaxed with the following: in an 80 MHz operating channel, at most two backoff 20 MHz channels are allowed. The NPCA primary channel may be in secondary 40 MHz channel.

Some implementations of single non-primary backoff channel (NPCA primary channel), for example, by the wireless communications system 100 depicted in FIG. 1, the multi-link (ML) communications system 200 depicted in FIG. 2, and/or the wireless device 300 depicted in FIG. 3 are described. In some embodiments, with single non-primary backoff channel (a 20 MHz non-primary channel on which the backoff is conducted), if the primary channel is busy because of an OBSS TXOP, an OBSS PPDU, and/or an AP's in-device non-WiFi radio activity SP, the AP and its associated STAs may switch to non-primary backoff channel for frame exchanges until the primary channel is idle again. Additionally, the following information can be considered. In some embodiments, if the OBSS TXOP's BW (the BW of the inter-BSS PPDU) covers the non-primary backoff channel, the AP and STAs will not switch to the non-primary backoff channel. In some embodiments, if the length of the TXOP is less than a threshold announced by the AP, the AP and STAs will not switch to the non-primary backoff channel.

Some implementations of multiple non-primary backoff channels, for example, by the wireless communications system 100 depicted in FIG. 1, the multi-link (ML) communications system 200 depicted in FIG. 2, and/or the wireless device 300 depicted in FIG. 3 are described.

In some embodiments, with multiple non-primary backoff channels, if the primary channel is busy because of an OBSS TXOP and an AP's in-device non-WiFi radio activity SP, the AP and its associated STAs may switch to one of the non-primary backoff channels for frame exchanges until the primary channel is idle again. Additionally, the following information can be considered. In some embodiments, if the OBSS TXOP's BW (the BW of the inter-BSS PPDU) covers all the non-primary backoff channels, the AP and STAs will not switch to the non-primary backoff channel. In some embodiments, if the length of the TXOP is less than a threshold announced by the AP, the AP and STAs will not switch to the non-primary backoff channel. The length of the TXOP may be decided by sum of the remaining time of the detected PPDU and the value in the Duration field of a MAC header (e.g., in the TXOP Duration filed of the PHY header). In some embodiments, the AP announces the priority of the various non-primary backoff channels. In some embodiments, a non-primary backoff channel that has the highest priority and is not covered by the primary channel behavior (per the BW of the OBSS TXOP etc.) will be the non-primary backoff channel to be switched to for the frame exchanges.

Some implementations of switching among non-primary backoff channels or not are described. In some embodiments, in a first option, the switching from one non-primary backoff channel to another non-primary channel is disallowed. In some embodiments, in a second option, the switching from one non-primary backoff channel to another non-primary channel is allowed. In some embodiments, in order to increase the chance that AP and STAs switch to the same non-primary backoff channel, the following are defined. In some embodiments, the AP and STAs switch from non-primary backoff channel 1 to non-primary backoff channel 2 if the following are true:
that non-primary backoff channel 2 has lower priority than non-primary backoff channel 1 (there is no another non-primary backoff channel with the priority higher than non-primary backoff channel 2 and lower than non-primary backoff 20 MHz channel 1);
that the OBSS activity (e.g., an OBSS TXOP or an OBSS PPDU) of the non-primary backoff channel 1 is longer than a threshold; and
that the remaining time of OBSS activity (e.g., an OBSS TXOP or an OBSS PPDU) is longer than a threshold.

Some implementations of switch delay announcements, for example, by the wireless communications system 100 depicted in FIG. 1, the multi-link (ML) communications system 200 depicted in FIG. 2, and/or the wireless device 300 depicted in FIG. 3 are described. The switch time between an NPCA primary channel (secondary backoff channel) and the primary channel needs to be announced to the peer device. In some embodiments, the switch time between an NPCA primary channel and the primary channel should be an operating parameter because when a STA's operating BW changes, the channel switch delay (switch time) may change, e.g., the channel switch time when the STA's operating BW cover NPCA primary channel and the channel switch time when the STA's operating BW does not cover NPCA primary channel are different. This means that the switch time between NPCA primary channel and the primary channel needs to be announced when a STA negotiates its enabling of NPCA operation, the switch time is announced. In some embodiments, an AP announces its channel switch time between primary channel and NPCA primary channel (switch time from primary channel to NPCA primary channel, and switch time from NPCA primary channel to primary channel) in its Beacon.

In some embodiments, the granularity of Enhanced Multi-Link-Single-Radio (EMLSR)/Enhanced Multi-Link-Multi-Radio (EMLMR) is not linear where the maximal granularity is 128 microseconds (μs) (0, 32, 64, 128, 256 μs). The large granularity may waste the medium time. The padding time of IEEE 802.11ax has granularity of 8 μs (e.g., 0, 8, 16 μs). Granularity of 1 μs may increase the medium efficiency a little bit, e.g., a Buffer Status Report Poll (BSRP) Trigger with 2 μs room to carry all the addressed STAs' User Info fields does not need additional orthogonal frequency-division multiplexing (OFDM) symbols to carry the padding field if all the padding requirement of all the addressed STAs are no more than 2 μs, without increasing the implementation complexity. A device can select a larger padding time when a peer device announces a smaller value. In some embodiments, the 1 μs granularity is preferable. Otherwise, the granularity should be linear increased, e.g., in 4 μs granularity (0, 4, 8, 12, 16, . . . , 252, 256), in 8 μs granularity (0, 8, 16, 24, 32, . . . , 248, 256) or 16 μs granularity (0, 16, 32, 48 . . . , 240, 256).

Some implementations of available secondary channels, for example, by the wireless communications system 100 depicted in FIG. 1, the multi-link (ML) communications system 200 depicted in FIG. 2, and/or the wireless device 300 depicted in FIG. 3 are described.

In some embodiments, when the duration of an OBSS PPDU is used to decide the maximal staying time on an NPCA primary channel, secondary channels occupied by the OBSS PPDU cannot be selected by the TXOP holder to conduct the frame exchanges in a TXOP through the backoff on the NPCA primary channel. In some embodiments, for the other secondary channel(s), if they are not idle Point Coordination Function (PCF) Inter-frame space (PIFS) before the TXOP holder's initial PPDU, they cannot be combined with the NPCA primary channel for the frame exchanges. In some embodiments, if the combination of the secondary channels does not satisfy the IEEE 802.11be channel puncture rules with NPCA primary channel being treated as the primary channel, they cannot be combined with the NPCA primary channel for the frame exchanges.

In some embodiments, when the duration of an OBSS TXOP is used to decide the maximal staying time on an NPCA primary channel, a secondary channel occupied by the OBSS TXOP BW cannot be selected by the TXOP holder to do the frame exchanges in a TXOP through the backoff on the NPCA primary channel. In some embodiments, the OBSS TXOP BW is the BW decided by the OBSS control frame exchange that triggers the switch to the NPCA primary channel. In some embodiments, for the other secondary channel(s), if they are not idle PIFS before the TXOP holder's initial PPDU, they cannot be combined with the NPCA primary channel for the frame exchanges. In some embodiments, if the combination of the secondary channels does not satisfy the IEEE 802.11be channel puncture rules with NPCA primary channel being treated as the primary channel, they cannot be combined with the NPCA primary channel for the frame exchanges.

Some implementations of a TXOP responder's polling in non-primary channel, for example, by the wireless communications system 100 depicted in FIG. 1, the multi-link (ML) communications system 200 depicted in FIG. 2, and/or the wireless device 300 depicted in FIG. 3 are described. In some embodiments, a (multi-user (MU)-) RTS/CTS is used if a single STA (or an AP) is polled before conducting the frame exchanges in a non-primary channel. In some embodiments, if multiple STAs are polled, the BSRP Trigger or the Bandwidth Query Report Poll (BQRP) Trigger is used. In some embodiments, in another variant, the MU-RTS can be used.

Some implementations of virtual AP consideration, for example, by the wireless communications system 100 depicted in FIG. 1, the multi-link (ML) communications system 200 depicted in FIG. 2, and/or the wireless device 300 depicted in FIG. 3 are described. In some embodiments, APs that belong to a multiple basic service set identifier (BSSID) set and enable NPCA need to have the same NPCA primary channel. In some embodiments, the criteria to switch from the primary channel to the NPCA primary channel need to be same for all APs that belong to a multiple BSSID set and support the switch, e.g., OBSS activity threshold for the switch, switch time from the primary channel to the NPCA primary channel, switch time from the primary channel to the NPCA primary channel. In some embodiments, the APs that belong to a co-hosted BSSID set and enable NPCA need to have the same NPCA primary channel. In some embodiments, the criteria to switch from the primary channel to the NPCA primary channel needs to be same for all APs that belong to a co-hosted BSSID set and support the switch, e.g., OBSS activity threshold for the switch, switch time from the primary channel to the NPCA primary channel, switch time from the primary channel to the NPCA primary channel.

Some implementations of eMLSR mode, for example, by the wireless communications system 100 depicted in FIG. 1, the multi-link (ML) communications system 200 depicted in FIG. 2, and/or the wireless device 300 depicted in FIG. 3 are described. In some embodiments, in a first option, a STA in an eMLSR link will not switch to NPCA primary channel when the primary channel is busy. In some embodiments, in a second option, a STA in an eMLSR link will switch to NPCA primary channel when the primary channel is busy because of the OBSS activity. In some embodiments, if a STA in an eMLSR link that conducts frame exchanges with the AP in the NPCA primary channel decides to switch back to listening mode stays in the NPCA primary channel until the end of the OBSS activity in the primary channel.

Some implementations of R-TWT (Restricted Target Wake Time), for example, by the wireless communications system 100 depicted in FIG. 1, the multi-link (ML) communications system 200 depicted in FIG. 2, and/or the wireless device 300 depicted in FIG. 3 are described. R-TWT (Restricted Target Wake Time) can reserve the medium for the low latency traffic streams of wireless devices that are a part of the R-TWT schedule membership. Other STAs may end any ongoing communication at the start time of an advertised R-TWT SP (Service Period).

A solution for R-TWT and non-primary channel usage is that when switching to a non-primary subchannel, the R-TWT rules are used as it is. However, the R-TWT members may not support subchannel switch.

In some embodiments, in a variant, an AP announces through Management frames (e.g. in Beacons) that the R-TWT rules are not applied when switching to a non-primary subchannel if no R-TWT STA supports NPCA primary channel switch. The STAs will act accordingly per AP's announcement. The AP may not stop its non-low latency traffic frame exchanges at the start time of its R-TWT SP if no R-TWT STA supports NPCA primary channel switch. Further, the AP may not stop its non-low latency traffic frame exchanges at the start time of a R-TWT SP if no member of the R-TWT SP supports NPCA primary channel switch.

In some embodiments, in another variant, at the end of the OBSS activity in the primary channel, the AP and the members of a R-TWT SP will not switch back to the primary channel if the following are true:
that all the members of the R-TWT SP support the NPCA primary channel switch, and
that the R-TWT SP does not end at the end of the OBSS TXOP in the primary channel.

Some implementations of Target Beacon Transmission Time (TBTT) activities, for example, by the wireless communications system 100 depicted in FIG. 1, the multi-link (ML) communications system 200 depicted in FIG. 2, and/or the wireless device 300 depicted in FIG. 3 are described. In some embodiments, when an AP as the TXOP holder has a TXOP in non-primary channel(s) that covers its TBTT, the AP will not schedule its Beacon transmission at its TBTT. In some embodiments, when an AP as the TXOP holder has a TXOP in non-primary channel(s) that covers its TBTT for delivery traffic indication map (DTIM) bacon, the AP will not schedule its group-addressed frame transmission at its TBTT for DTIM beacon.

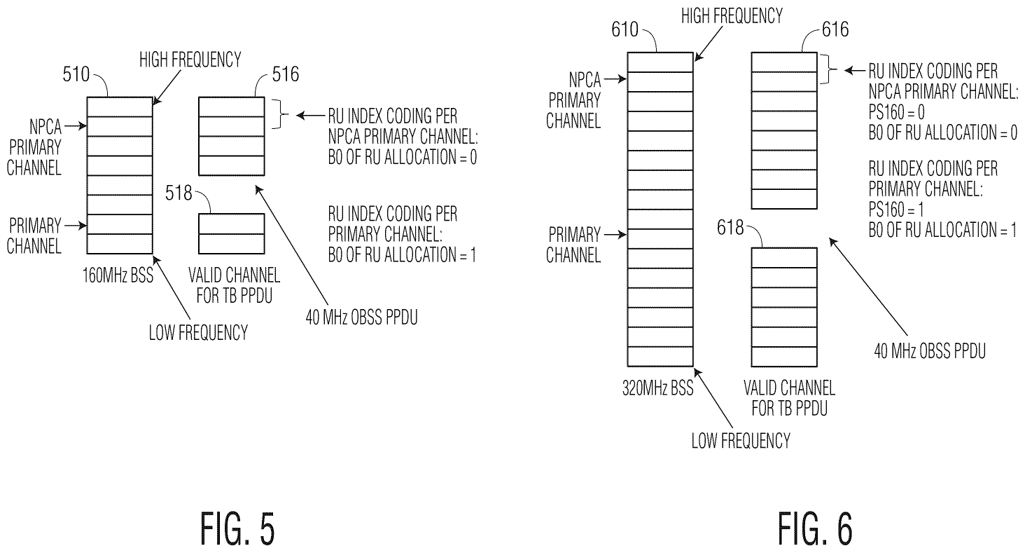

FIGS. 5-15 depict some examples of RU index configurations. In the RU index configurations depicted in FIGS. 5-15, B0 may represent the lowest bit in RU Allocation field of the Trigger frame soliciting the Trigger-based (TB) PPDU. Each TB PPDU may be solicited by a Trigger frame. Each RU of the TB PPDU may be defined by the RU index coding of a User Info field. A RU index may be defined by a RU Allocation field and a PS160 field.

Some implementations of RU index and TXOP protection, for example, by the wireless communications system 100 depicted in FIG. 1, the multi-link (ML) communications system 200 depicted in FIG. 2, and/or the wireless device 300 depicted in FIG. 3 are described.

When an AP solicits a TB PPDU from STAs after an NPCA primary channel's backoff, the BW of a soliciting Trigger frame may cover both primary channel and NPCA primary channel. The RU index for the same RU (covering the same 20 MHz channels) may be different when the different channel being treated as primary channel for RU index coding in the soliciting Trigger frame. The STAs do not do the NPCA primary channel switch since the OBSS activity is missing and the STAs do the NPCA primary channel switch may have the different view of the backoff channel. FIG. 5 depicts an example RU index configuration related to the RU covering the highest frequency 40 MHz in a Trigger frame that solicits the TB PPDU covering a primary channel and an NPCA primary channel of a 160 MHz BSS operating channel 510. In the 160 MHz BSS operating channel 510, which includes a primary channel and an NPCA primary channel, the RU Index coding of the RU covering the highest 40 MHz in a Trigger frame soliciting a TB PPDU 518 is described when a 40 MHz OBSS PPDU 516 is transmitted in the primary channel. In the example RU index related to the RU covering the highest frequency 40 MHz depicted in FIG. 5, for RU index coding of the RU covering the highest frequency 40 MHz per NPCA primary channel being treated as primary channel, B0 of RU Allocation field in soliciting Trigger frame describing the RU covering the highest 40 MHz is equal to 0, while for RU index coding related to the RU covering the highest frequency 40 MHz per primary channel, B0 of RU Allocation field in soliciting Trigger frame describing the RU covering the highest 40 MHz is equal to 1. FIG. 6 depicts an example RU index configuration of the RU covering the highest frequency 40 MHz in a Trigger frame soliciting a TB PPDU 618 covering a primary channel and an NPCA primary channel of a 320 MHz BSS operating channel 610. In the 320 MHz BSS operating channel 610, which includes a primary channel and one NPCA primary channel, the RU index coding of the RU covering the highest frequency 40 MHz in a Trigger frame soliciting the TB PPDU 618 is described when 40 MHz OBSS PPDU 616 is detected. In the example RU index configuration depicted in FIG. 6, for RU index coding of RU covering the highest 40 MHz frequency per NPCA primary channel being treated as primary channel, PS160 field in Trigger frame soliciting the TB PPDU is equal to 0, B0 of RU Allocation field in Trigger frame soliciting the TB PPDU is equal to 0, while for RU index coding per primary channel, PS160 field for the RU covering the highest frequency 40 MHz in Trigger frame soliciting the TB PPDU is equal to 1, B0 of RU Allocation for the RU covering the highest frequency 40 MHz is equal to 1.

In some embodiments, in a first option of RU index and TXOP protection, if/when an NPCA primary channel is used to conduct the frame exchanges because of the backoff counter in the NPCA primary channel becomes 0, the RU index of the Trigger frame soliciting TB PPDU is acquired based on the PPDU BW and through treating the NPCA primary channel as the primary channel. In some embodiments, backoff channel indication in a Trigger frame indicates the NPCA primary channel that is used for RU index coding, i.e., the Trigger frame indicates that trigger frame is transmitted via the NPCA primary channel (after the backoff counter in the NPCA channel becomes zero). In some embodiments, if the backoff counter in a NPCA primary channel becomes 0, the dynamic BW negotiation is performed through treating the NPCA primary channel as the primary channel. In some embodiments, the single-user (SU) PPDU and non-High Throughput (HT) duplicated PPDU is based on the occupied BW.

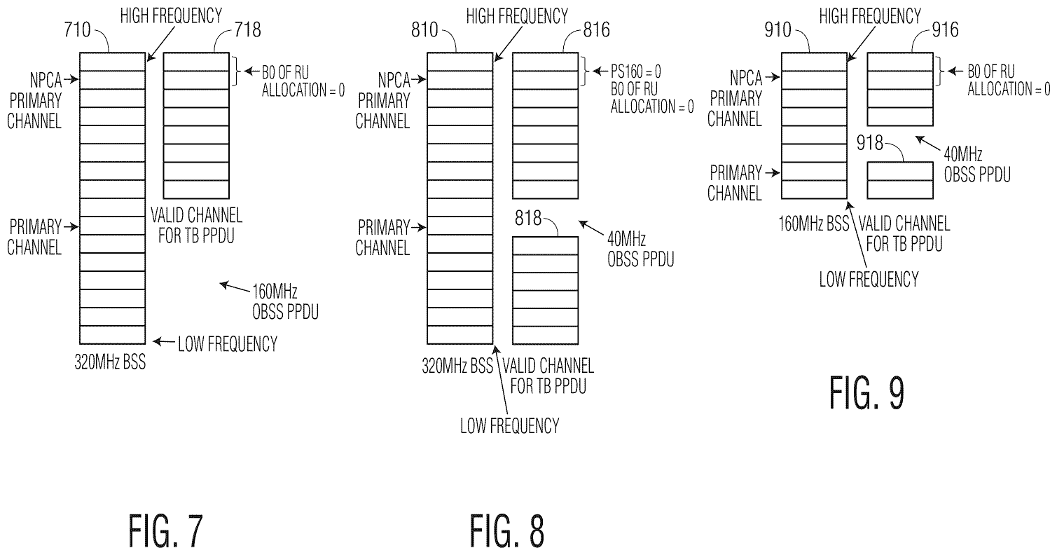

FIG. 7 depicts an RU index configuration for a 320 MHz BSS operating channel 710 in accordance with an embodiment of the invention. In the 320 MHz BSS operating channel 710, which includes a primary channel and an NPCA primary channel, a TB PPDU 718 is solicited by a Trigger frame on the NPCA primary channel after the backoff counter on the NPCA primary channel becomes 0 where the 160 MHz OBSS PPDU triggers the switch to the NPCA primary channel. The Trigger frame soliciting the TB PPDU 718 indicates that the RU Index is based on the NPCA primary channel, i.e., the Trigger frame soliciting the TB PPDU 718 indicates that trigger frame is transmitted via the NPCA primary channel (after the backoff counter in the NPCA channel becomes zero). In the Trigger frame soliciting the TB PPDU 718, B0 of RU Allocation field related to the RU covering the highest 40 MHz RU is equal to 0.

FIG. 8 depicts an RU index configuration for a 320 MHz BSS operating channel 810 in accordance with an embodiment of the invention. In the 320 MHz BSS operating channel 810, which includes a primary channel and an NPCA primary channel, a TB PPDU 818 is solicited by a Trigger frame after the backoff timer on the NPCA primary channel becomes 0 where the 40 MHz OBSS PPDU 816 triggers the switch to the NPCA primary channel. The Trigger frame soliciting the TB PPDU 818 indicates that the RU Index is based on the NPCA primary channel, i.e., the Trigger frame soliciting the TB PPDU 818 indicates that trigger frame is transmitted via the NPCA primary channel (after the backoff counter in the NPCA channel becomes zero). In the Trigger frame soliciting the TB PPDU 818, PS160 field related to the RU covering the highest 40 MHz RU is equal to 0, B0 of RU Allocation field related to the RU covering the highest 40 MHz RU is equal to 0.

FIG. 9 depicts an RU index configuration for a 160 MHz BSS operating channel 910 in accordance with an embodiment of the invention. In the 160 MHz BSS operating channel 910, which includes a primary channel and an NPCA primary channel, a TB PPDU 918 is solicited by a Trigger frame after backoff on the NPCA primary channel becomes 0 where the 40 MHz OBSS PPDU 916 triggers the switch to the NPCA primary channel. The Trigger frame soliciting the TB PPDU 918 indicates that the RU Index is based on the NPCA primary channel, i.e., the Trigger frame soliciting the TB PPDU 918 indicates that trigger frame is transmitted via the NPCA primary channel (after the backoff counter in the NPCA channel becomes zero). In the Trigger frame soliciting TB PPDU 918, B0 of RU Allocation field related to the RU covering the highest 40 MHz RU is equal to 0.

In some embodiments, in a second option of RU index and TXOP protection, if/when a backoff counter in a non-primary backoff 20 MHz channel becomes 0, the RU index is acquired based on the BW of a TB/MU PPDU and the covered backoff 20 MHz channel with the highest priority. In some embodiments, in a BSS with primary channel and a NPCA primary channel, the primary channel has the higher priority than NPCA primary channel. In some embodiments, an AP announces the priority of backoff 20 MHz channels, e.g., the priority from highest to lowest in the following example is primary channel, backoff 20 MHz channel 3 (NPCA primary channel 2), backoff 20 MHz channel 4 (NPCA primary channel 3), backoff 20 MHz channel 2 (NPCA primary channel 1). In some embodiments, if/when the backoff counter in a non-primary backoff 20 MHz channel becomes 0, the dynamic BW negotiation is conducted through treating the non-primary backoff 20 MHz channel as the primary 20 MHz channel. In some embodiments, the SU PPDU and non-HT duplicated PPDU is based on the occupied BW.

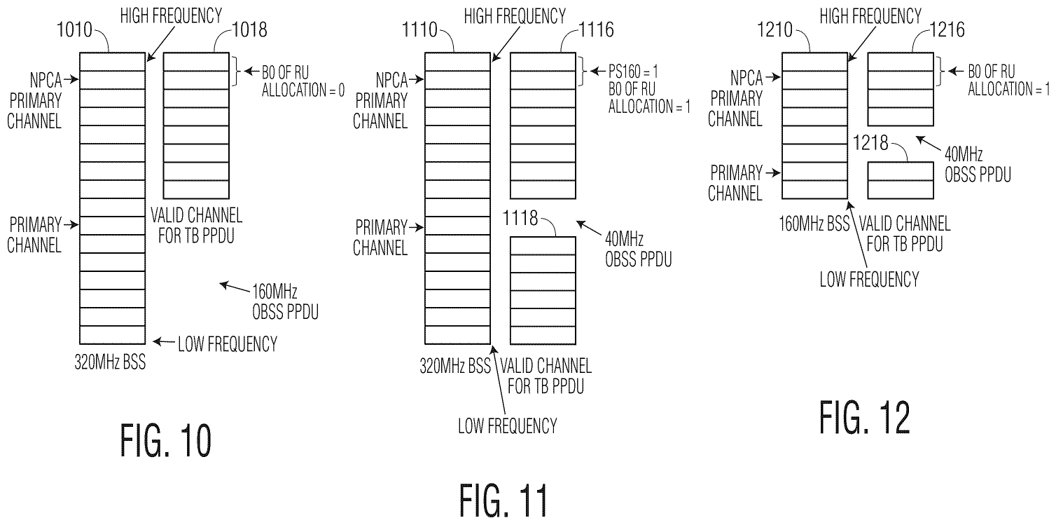

FIG. 10 depicts an RU index configuration for a 320 MHz BSS operating channel 1010 in accordance with an embodiment of the invention. The 320 MHz BSS operating channel 1010, which includes a primary channel and an NPCA primary channel, a TB PPDU 1018 is solicited by a Trigger frame after backoff on the NPCA primary channel becomes 0. The NPCA primary channel is the only backoff channel being covered by the TB PPDU1018 and the NPCA primary channel is treated as primary channel when doing the RU coding of TB PPDU 1018. In Trigger frame soliciting the TB PPDU 1018, B0 of RU Allocation field related to the RU covering the highest 40 MHz RU=0.

FIG. 11 depicts an RU index configuration for a 320 MHz BSS operating channel 1110 in accordance with an embodiment of the invention. The 320 MHz BSS operating channel 1110, which includes a primary channel and an NPCA primary channel, a TB PPDU 1118 is solicited by a Trigger frame after the backoff timer on the NPCA primary channel becomes 0 where the 40 MHz OBSS PPDU 1116 triggers the switch to the NPCA primary channel. The NPCA primary channel and the primary channel are the backoff channel being covered by the TB PPDU1118 and the backoff channel with higher priority, i.e. primary channel, is treated as primary channel when doing the RU coding of TB PPDU 1018. In the Trigger frame soliciting the TB PPDU 1118, PS160 field related to the RU covering the highest 40 MHz RU is equal to 1, B0 of RU Allocation field related to the RU covering the highest 40 MHz RU is equal to 1.

FIG. 12 depicts an RU index configuration for a 160 MHz BSS operating channel 1210 in accordance with an embodiment of the invention. The 160 MHz BSS operating channel 1210, which includes a primary channel and an NPCA primary channel, a TB PPDU 1218 is solicited by a Trigger frame after backoff on the NPCA primary channel becomes 0 where the 40 MHz OBSS PPDU 1216 triggers the switch to the NPCA primary channel. The NPCA primary channel and the primary channel are the backoff channel being covered by TB PPDU1218 and the backoff channel with higher priority, i.e. primary channel, is treated as primary channel when doing the RU coding of TB PPDU 1018. In the Trigger frame soliciting TB PPDU 1218, B0 of RU Allocation field related to the RU covering the highest 40 MHz RU is equal to 1.

In some embodiments, in a third option of RU index and TXOP protection, if/when a backoff counter in a non-primary backoff 20 MHz channel becomes 0, the RU index is acquired based on the whole BSS BW. One variant of the TB/MU PPDU's BW is the BSS operating channel's BW. Another variant of the TB/MU PPDU's BW is the real BW of the TB/MU PPDU. One example is that in a 320 MHz BSS operating channel, an AP and STAs switch to non-primary 160 MHz channel. In some embodiments, the RU Indexes of various RUs in 160 MHz TB PPDU on secondary 160 MHz channel are coded as the RUs in secondary 160 MHz of 320 MHz TB PPDU. In some embodiments, if/when the backoff counter in a non-primary backoff 20 MHz channel becomes 0, the dynamic BW negotiation is done through treating the non-primary backoff 20 MHz channel as the primary 20 MHz channel. In some embodiments, the SU PPDU and non-HT duplicated PPDU is based on the occupied BW.

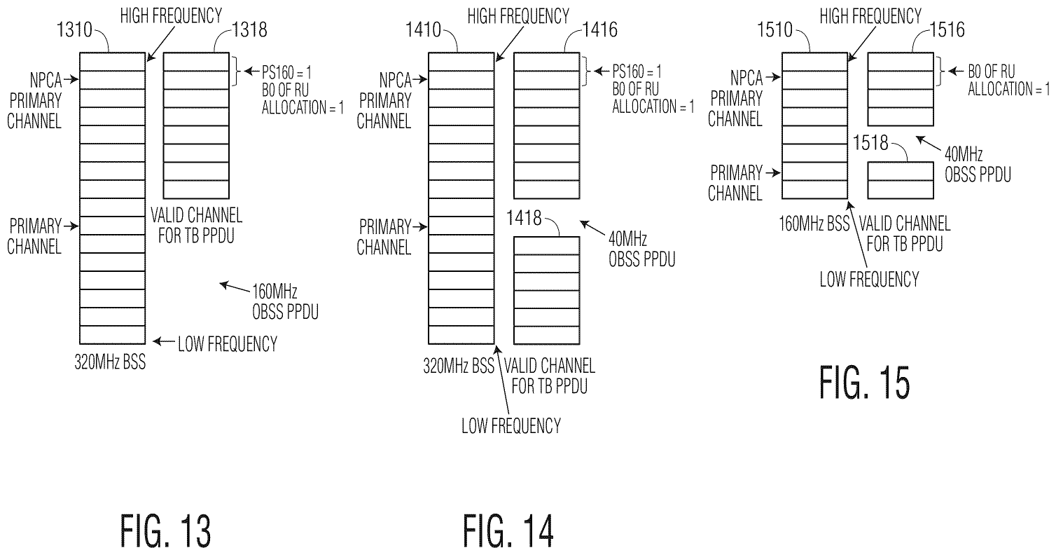

FIG. 13 depicts an RU index configuration for a 320 MHz BSS operating channel 1310 in accordance with an embodiment of the invention. The 320 MHz BSS operating channel 1310, which includes a primary channel and an NPCA primary channel, a TB PPDU 1318 is solicited by a Trigger frame after backoff on the NPCA primary channel becomes 0. In Trigger frame soliciting the TB PPDU 1318, B0 of RU Allocation field related to the RU covering the highest 40 MHz RU=1.

FIG. 14 depicts an RU index configuration for a 320 MHz BSS operating channel 1410 in accordance with an embodiment of the invention. The 320 MHz BSS operating channel 1410, which includes a primary channel and an NPCA primary channel, a TB PPDU 1418 is solicited by a Trigger frame after the backoff timer on the NPCA primary channel becomes 0 where the 40 MHz OBSS PPDU 1416 triggers the switch to the NPCA primary channel. In the Trigger frame soliciting the TB PPDU 1418, PS160 field related to the RU covering the highest 40 MHz RU is equal to 1, B0 of RU Allocation field related to the RU covering the highest 40 MHz RU is equal to 1.

FIG. 15 depicts an RU index configuration for a 160 MHz BSS operating channel 1510 in accordance with an embodiment of the invention. The 160 MHz BSS operating channel 1510, which includes a primary channel and an NPCA primary channel, a TB PPDU 1518 is solicited by a Trigger frame after backoff on the NPCA primary channel becomes 0 where the 40 MHz OBSS PPDU 1516 triggers the switch to the NPCA primary channel. In the Trigger frame soliciting TB PPDU 1518, B0 of RU Allocation field related to the RU covering the highest 40 MHz RU is equal to 1.

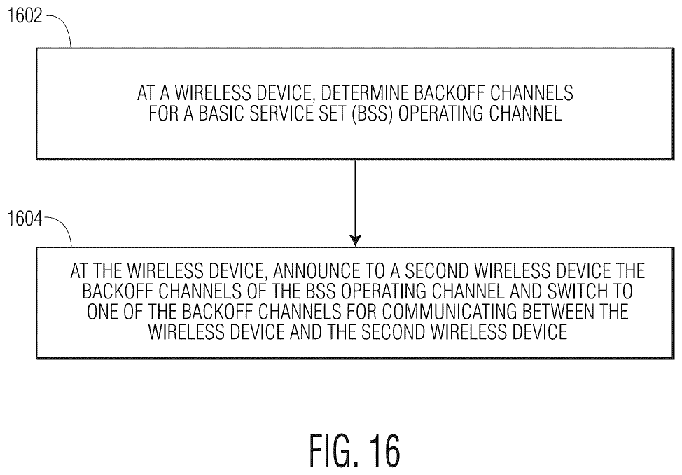

FIG. 16 is a process flow diagram of a method for wireless communications in accordance with an embodiment of the invention. At block 1602, at a wireless device, backoff channels are determined for a Basic Service Set (BSS) operating channel. At block 1604, at the wireless device, the backoff channels of the BSS operating channel are announced to a second wireless device and one of the backoff channels for communicating between the wireless device and the second wireless device is switched to. In some embodiments, the one of the backoff channels for communicating between the wireless device and the second wireless device is switched to when an Overlapping Basic Service Set (OBSS) activity satisfies a channel switch condition. In some embodiments, the one of the backoff channels is switched to for communicating between the wireless device and the second wireless device at a start of an OBSS transmit opportunity (TXOP) or an OBSS physical layer protocol data unit (PPDU). In some embodiments, the backoff channels include a primary channel and a non-primary backoff channel the BSS operating channel. In some embodiments, a first data unit is wirelessly transmitted to the second wireless device in the non-primary backoff channel or a second data unit is wirelessly received from the second wireless device in the non-primary backoff channel. In some embodiments, a non-primary channel access (NPCA) channel switch operation is executed to switch to the non-primary backoff channel from the primary channel for communicating between the wireless device and the second wireless device when an OBSS activity covering the primary channel satisfies an NPCA primary channel switch condition. In some embodiments, the NPCA primary channel switch operation is executed to switch to the non-primary backoff channel from the primary channel for communicating between the wireless device and the second wireless device at a start of an OBSS TXOP or an OBSS PPDU. In some embodiments, the NPCA primary channel switch operation is executed to switch to the non-primary backoff channel for communicating between the wireless device and the second wireless device when the primary channel is busy. In some embodiments, the one of the backoff channels includes one 20 Megahertz (MHz) channel. In some embodiments, the BSS operating channel includes a 160 MHz BSS operating channel or a 320 MHz BSS operating channel, and a primary channel and a secondary backoff channel are located in a primary 80 MHz channel of the 160 MHz BSS operating channel and a secondary 80 MHz channel of the 160 MHz BSS operating channel, respectively, or located in a primary 160 MHz channel of the 320 MHz BSS operating channel and a secondary 160 MHz channel of the 320 MHz BSS operating channel, respectively. In some embodiments, different priorities are allocated to the backoff channels. In some embodiments, the backoff channels are announced to the second wireless device using a management frame, and the management frame is one of a beacon frame, a probe response frame, and an association response frame. In some embodiments, at a first wireless device, backoff channels for a BSS operating channel that include a primary channel and a non-primary channel access (NPCA) primary channel are determined and the backoff channels of the BSS operating channel are announced to a second wireless device and the NPCA primary channel is switched to for communicating between the first wireless device and the second wireless device, for example, through the at least one antenna. In some embodiments, the NPCA primary channel for communicating between the wireless device and the second wireless device is switched to when an OBSS activity satisfies a channel switch condition. In some embodiments, the NPCA primary channel for communicating between the wireless device and the second wireless device is switched to at a start of an OBSS TXOP or an OBSS physical layer protocol data unit (PPDU), and the channel switch condition announced to the second wireless device includes an OBSS activity duration threshold. In some embodiments, when an OBSS PPDU length or OBSS TXOP remaining time is longer than the OBSS activity duration threshold, the wireless device and the second wireless device switch to the NPCA primary channel until the end of the OBSS activity is detected. In some embodiments, a switch delay from the primary channel to the

NPCA primary channel and a switch delay from the NPCA primary channel to the primary channel are announced to the second wireless device. In some embodiments, the second wireless device's switch delay from the primary channel to the NPCA primary channel and a switch delay from the NPCA primary channel to the primary channel are received from the second wireless device. In some embodiments, frame exchanges are executed in the NPCA primary channel after a backoff counter in the NPCA primary channel becomes zero. In some embodiments, a trigger frame is transmitted to solicit a Trigger-based (TB) PPDU from the second wireless device. In some embodiments, the NPCA primary channel is treated as the primary channel to perform a resource unit (RU) index coding to be carried in a RU allocation field and a PS160 field. In some embodiments, it is indicated in the trigger frame that the RU index coding is based on the NPCA primary channel as the primary channel such that the trigger frame is transmitted after the backoff counter in the NPCA primary channel becomes zero. In some embodiments, a dynamic bandwidth negotiation treats the NPCA primary channel as the primary channel. In some embodiments, the BSS operating channel is a 160 MHz BSS operating channel or a 320 MHz BSS operating channel, and the primary channel and the NPCA primary channel are located in a primary 80 MHz channel of the 160 MHz BSS operating channel and a secondary 80 MHz channel of the 160 MHz BSS operating channel, respectively, or located in a primary 160 MHz channel of the 320 MHz BSS operating channel and a secondary 160 MHz channel of the 320 MHz BSS operating channel, respectively. In some embodiments, the BSS operating channel is an 80 MHz BSS operating channel, and where the primary channel and the NPCA primary channel are located in a primary 40 MHz channel of the 80 MHz BSS operating channel and a secondary 40 MHz channel of the 80 MHz BSS operating channel, respectively. In some embodiments, the wireless device includes a wireless access point (AP), and the second wireless device includes a non-AP station (STA) device. In some embodiments, the wireless device is compatible with an Institute of Electrical and Electronics Engineers (IEEE) 802.11 protocol. In some embodiments, the wireless device is a component of a multi-link device (MLD). The wireless device may be the same as or similar to an embodiment of the AP 106 depicted in FIG. 1, the APs 206-1, 206-2 depicted in FIG. 2, and/or the wireless device 300 depicted in FIG. 3. The second wireless device may be the same as or similar to an embodiment of the at least one STA 110-1, . . . , 110-n depicted in FIG. 1, the non-AP STAs 210-1 and 210-2 depicted in FIG. 2, and/or the wireless device 300 depicted in FIG. 3.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

It should also be noted that at least some of the operations for the methods described herein may be implemented using software instructions stored on a computer useable storage medium for execution by a computer. As an example, an embodiment of a computer program product includes a computer useable storage medium to store a computer readable program.

The computer-useable or computer-readable storage medium can be an electronic, magnetic, optical, electromagnetic, infrared, or semiconductor system (or apparatus or device). Examples of non-transitory computer-useable and computer-readable storage media include a semiconductor or solid-state memory, magnetic tape, a removable computer diskette, a random-access memory (RAM), a read-only memory (ROM), a rigid magnetic disk, and an optical disk. Current examples of optical disks include a compact disk with read only memory (CD-ROM), a compact disk with read/write (CD-R/W), and a digital video disk (DVD).

Alternatively, embodiments of the invention may be implemented entirely in hardware or in an implementation containing both hardware and software elements. In embodiments which use software, the software may include but is not limited to firmware, resident software, microcode, etc.

Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. A wireless device comprising:
a controller configured to determine a plurality of backoff channels for a Basic Service Set (BSS) operating channel that comprise a primary channel and a non-primary channel access (NPCA) primary channel; and
a wireless transceiver configured to announce to a second wireless device the backoff channels of the BSS operating channel and to switch to the NPCA primary channel for communicating between the wireless device and the second wireless device.

2. The wireless device of claim 1, wherein the wireless transceiver is further configured to switch to the NPCA primary channel for communicating between the wireless device and the second wireless device when an Overlapping Basic Service Set (OBSS) activity satisfies a channel switch condition.

3. The wireless device of claim 2, wherein the wireless transceiver is further configured to switch to the NPCA primary channel for communicating between the wireless device and the second wireless device at a start of an OBSS transmit opportunity (TXOP) or an OBSS physical layer protocol data unit (PPDU), and wherein the channel switch condition announced to the second wireless device comprises an OBSS activity duration threshold.

4. The wireless device of claim 3, wherein when an OBSS PPDU length or OBSS TXOP remaining time is longer than the OBSS activity duration threshold, the wireless device and the second wireless device switch to the NPCA primary channel until an end of the OBSS activity is detected.

5. The wireless device of claim 1, wherein the wireless transceiver is further configured to announce to the second wireless device a switch delay from the primary channel to the NPCA primary channel and a switch delay from the NPCA primary channel to the primary channel.

6. The wireless device of claim 1, wherein the wireless transceiver is further configured to receive from the second wireless device the second wireless device's switch delay from the primary channel to the NPCA primary channel and a switch delay from the NPCA primary channel to the primary channel.

7. The wireless device of claim 3, wherein the wireless transceiver is further configured to execute a plurality of frame exchanges in the NPCA primary channel after a backoff counter in the NPCA primary channel becomes zero.

8. The wireless device of claim 7, wherein the wireless transceiver is further configured to transmit a trigger frame to solicit a Trigger-based (TB) PPDU from the second wireless device.

9. The wireless device of claim 8, wherein the wireless transceiver is further configured to treat the NPCA primary channel as the primary channel to perform a resource unit (RU) index coding to be carried in a RU allocation field and a PS160 field.

10. The wireless device of claim 9, wherein the wireless transceiver is further configured to indicate in the trigger frame that the RU index coding is based on the NPCA primary channel as the primary channel such that the trigger frame is transmitted after the backoff counter in the NPCA primary channel becomes zero.

11. The wireless device of claim 7, wherein the wireless transceiver is further configured such that a dynamic bandwidth negotiation treats the NPCA primary channel as the primary channel.

12. The wireless device of claim 1, wherein the BSS operating channel is a 160 Megahertz (MHz) BSS operating channel or a 320 MHz BSS operating channel, and wherein the primary channel and the NPCA primary channel are located in a primary 80 MHz channel of the 160 MHz BSS operating channel and a secondary 80 MHz channel of the 160 MHz BSS operating channel, respectively, or located in a primary 160 MHz channel of the 320 MHz BSS operating channel and a secondary 160 MHz channel of the 320 MHz BSS operating channel, respectively.

13. The wireless device of claim 1, wherein the BSS operating channel is an 80 Megahertz (MHz) BSS operating channel, and wherein the primary channel and the NPCA primary channel are located in a primary 40 MHz channel of the 80 MHz BSS operating channel and a secondary 40 MHz channel of the 80 MHz BSS operating channel, respectively.

14. The wireless device of claim 1, wherein the wireless device comprises a wireless access point (AP), and wherein the second wireless device comprises a non-AP station (STA) device.

15. The wireless device of claim 1, wherein the wireless device is compatible with an Institute of Electrical and Electronics Engineers (IEEE) 802.11 protocol.

16. The wireless device of claim 1, wherein the wireless device is a component of a multi-link device (MLD).

17. A wireless access point (AP) comprising:
a controller configured to determine a primary channel and at least one non-primary channel access (NPCA) primary channel for a Basic Service Set (BSS) operating channel; and
a wireless transceiver configured to announce to a second wireless device the primary channel and the at least one NPAC primary channel of the BSS operating channel and to execute a non-primary channel access (NPCA) channel switch operation to switch to the at least one NPCA primary channel from the primary channel for communicating between the wireless AP and the second wireless device.

18. The wireless AP of claim 17, wherein the at least one NPCA primary channel comprises at least one 20 Megahertz (MHz) channel.

19. The wireless AP of claim 17, wherein the wireless AP is compatible with an Institute of Electrical and Electronics Engineers (IEEE) 802.11 protocol.

20. A method for wireless communications, the method comprising:
at a wireless device, determining a plurality of backoff channels for a Basic Service Set (BSS) operating channel; and
at the wireless device, announcing to a second wireless device the backoff channels of the BSS operating channel and switching to one of the backoff channels for communicating between the wireless device and the second wireless device.
